(19) United States
(12) Patent Application Publication
(10) Pub. No.: US 2008/0110715 A1
(43) Pub. Date: May 15, 2008

(54) Fluid actuated overrunning coupling assembly

(75) Inventor: Brice A. Pawley, Midland, MI (US)

Correspondence Address: BROOKS KUSHMAN P.C., 1000 TOWN CENTER, TWENTY-SECOND FLOOR, SOUTHFIELD, MI, 48075, US

(73) Assignee: Means Industries, Inc., Saginaw, MI (US)

(21) Appl. No.: 11/598,379

(22) Filed: Nov. 13, 2006

(51) Int. Cl. F16D 41/12

(52) U.S. Cl. 192/43.1

(57) ABSTRACT

A coupling assembly includes a first coupling member having a pocket and a fluid passage that extends toward the pocket, and a second coupling member having a locking formation. The assembly further includes an engaging member that is received in the pocket and that is engageable with the locking formation. The fluid passage is configured to supply pressurized fluid toward the pocket to move the engaging member into contact with the locking formation to effect torque transfer between the coupling members.

### BACKGROUND OF THE INVENTION

1. Field of the Invention

This invention relates to overrunning coupling assemblies.

2. Background Art

Overrunning coupling assemblies may be used for selectively transferring torque from one member to another member in a variety of applications. For example, an overrunning coupling assembly may be configured as a overrunning clutch that mechanically couples a driving member to a driven member only when the driving member rotates in a first direction relative to the driven member. Once so engaged, the clutch will release or decouple the driven member from the driving member only when the driving member rotates in a second, opposite direction relative to the driven member. Further, the clutch otherwise permits the driving member to freely rotate in the second direction relative to the driven member. Such “freewheeling” of the driving member in the second direction relative to the driven member is also known as the “overrunning” condition.

### BRIEF DESCRIPTION OF THE DRAWINGS

FIG. 1 is an end view of a coupling assembly according to the invention;

FIG. 2 is a cross-sectional view taken along line 2-2 of FIG. 1 and viewed in the direction of the arrows;

FIG. 3 is an enlarged fragmentary view of a portion of FIG. 1 showing a fluid actuated strut and a spring actuated strut;

FIG. 4 is an enlarged fragmentary view similar to FIG. 3, showing an exemplary configuration in which the fluid actuated strut is actuated directly by pressurized fluid;

FIG. 5 is an enlarged fragmentary cross-sectional view of a second embodiment of a coupling assembly that includes two fluid actuated struts;

FIG. 6 is an enlarged fragmentary cross-section view of a third embodiment of a coupling assembly that includes one strut received in a first coupling member, and another strut received in another coupling member;

FIG. 7 is an end view of a fourth embodiment of a coupling assembly according to the invention;

FIG. 8 is a cross-sectional view taken along line 8-8 of FIG. 7 and viewed in the direction of the arrows;

FIG. 9 is a cross-sectional view taken along line 9-9 of FIG. 7 and viewed in the direction of the arrows; and

FIG. 10 is a fragmentary cross-sectional view of a fifth embodiment of a coupling assembly according to the invention.

While exemplary overrunning coupling assemblies in accordance with the invention are illustrated and disclosed, such disclosure should not be construed to limit the claims. It is anticipated that various modifications and alternative designs may be made without departing from the scope of the invention.

### DETAILED DESCRIPTION

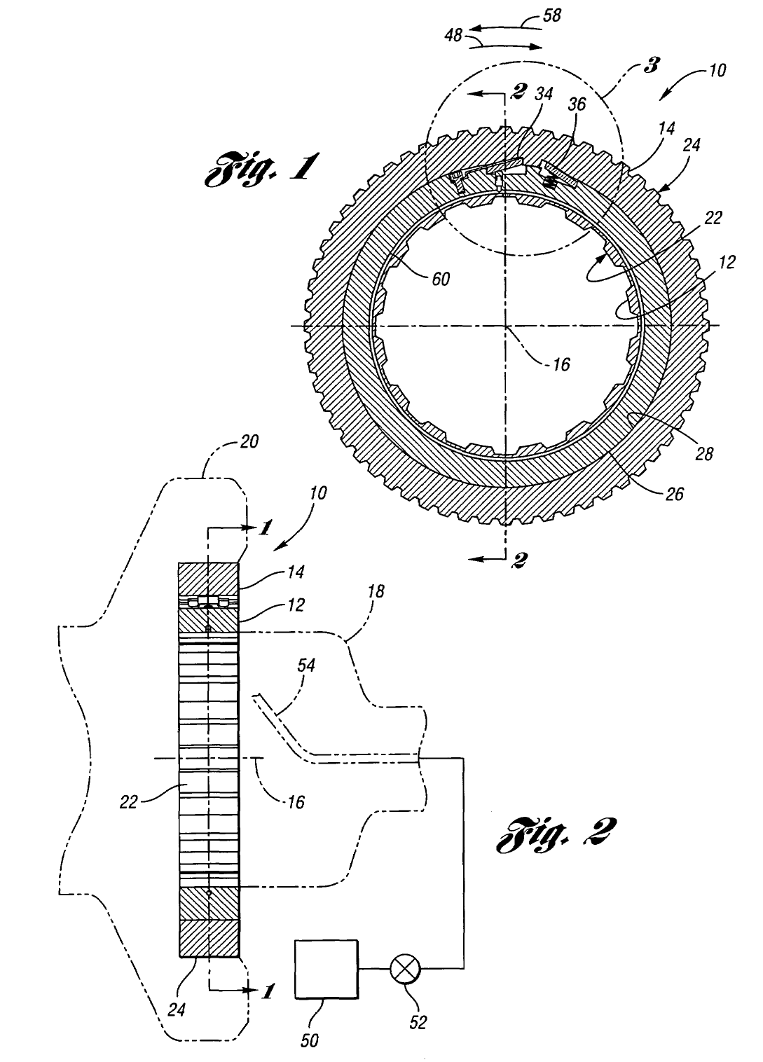

FIGS. 1-3 show a first exemplary overrunning coupling assembly according to the invention for use with a motor vehicle or any other suitable application, such as an industrial application. The overrunning coupling assembly in this embodiment is configured as a radial clutch 10 having first and second coupling members, such as first and second clutch members 12 and 14, respectively. The clutch members 12 and 14 are rotatably supported with respect to each other for relative rotation about a rotational axis 16 of the clutch 10. For example, the first clutch member 12 may be a driving member that is coupled to a drive shaft 18, or other suitable arrangement, and the second clutch member 14 may be a driven member that is coupled to a driven shaft 20, or other suitable arrangement. As another example, the first clutch member 12 may be a driven member, and the second clutch member 14 may be a drive member. As yet another example, one of the clutch members 12 or 14 may be stationary.

Although the clutch members 12 and 14 may be coupled to the shafts 18 and 20 in any suitable manner, in the embodiment shown in FIGS. 1-3, the first clutch member 12 includes a splined inner surface 22 that receives the drive shaft 18, and the second clutch member 14 has a splined outer surface 24 that receives the driven shaft 20. Moreover, the first clutch member 12 has a coupling face 26 that opposes a coupling face 28 of the second clutch member 14. In this embodiment, the coupling faces 26 and 28 are generally annular and face generally radially with respect to the axis 16.

The coupling face 26 of the first clutch member 12 has first and second pockets 30 and 32, respectively, that receive first and second engaging members, such as first and second pawls or struts 34 and 36, respectively. The struts 34 and 36 are moveable with respect to the first clutch member 12 such that the first and second struts 34 and 36, respectively, are selectively engageable with first and second locking formations 38 and 40, respectively, such as notches, formed in the coupling face 28 of the second clutch member 14, as explained below in detail. For example, the struts 34 and 36 may be pivotally moveable in opposite directions such that ends of the struts 34 and 36 project outwardly of the associated pockets 30 and 32.

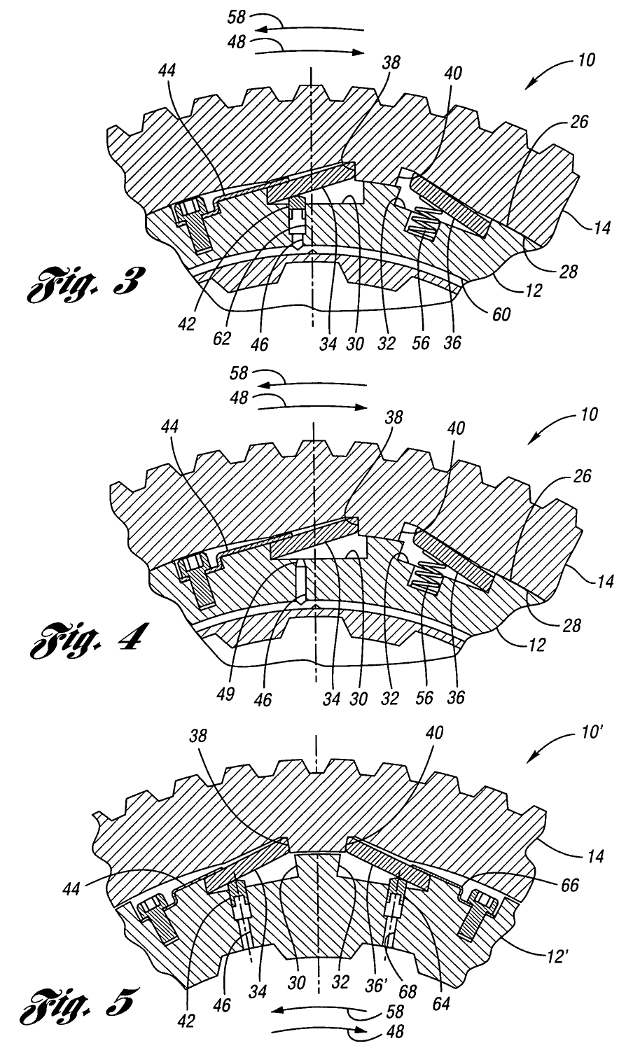

Referring to FIG. 3, the clutch 10 further includes a piston 42 that is moveable into the first pocket 30 for urging the first strut 34 into contact with the first locking formation 38, and a first biasing member, such as a first spring 44, attached to the first clutch member 12 for biasing the first strut 34 against pivotal movement. A first fluid passage 46 is formed in the first clutch member 12 for selectively supplying pressurized fluid, such as hydraulic fluid, toward the first pocket 30 to move the piston 42 into the first pocket 30. Upon supply of pressurized fluid to the first fluid passage 46, the piston 42 engages the first strut 34 and pivots the associated strut end against the bias of the first spring 44 and into contact with the first locking formation 38 to couple the clutch members 12 and 14 for rotation with each other in a first direction 48 about the axis 16. Upon termination of the supply of pressurized fluid to the first fluid passage 38, the first spring 44 is configured to move the end of the first strut 34 back into the first pocket 30 to permit relative rotational movement of the first clutch member 12 with respect to the second clutch member 14 in the first direction 48 about the axis 16.

Alternatively, the piston 42 may be eliminated if not required for a particular application. For example, the first fluid passage 46 may be configured to supply pressurized fluid directly into the first pocket 30 to move the end of the first strut 34 into engagement with the first locking formation 38. Referring to FIG. 4, for example, the first fluid passage 46 may have a tapered end 49 that is in fluid communication with the first pocket 30.

With any of the above configurations, pressurized fluid may be supplied to the first fluid passage 46 in any suitable manner. For example, referring to FIG. 2, pressurized fluid may be supplied by a pump 50 through a valve body 52 and into a channel 54 or other passage that extends through the drive shaft 18 and to the first fluid passage 46. The pump 50 and valve body 52 are operable to selectively supply pressurized fluid to the first fluid passage 46. Furthermore, pressurized fluid may be supplied at any suitable pressure, such as 20 to 300 pounds per square inch.

Referring to FIG. 3, a second biasing member, such as a second spring 56, is disposed in the second pocket 32 for pivoting the end of the second strut 36 out of the second pocket 32 and into engagement with the second locking formation 40 to couple the clutch members 12 and 14 for rotation with each other in a second direction 58, opposite the first direction 48, about the axis 16. Thus, the second strut 36 is oriented to cooperate with the second locking formation 40 in the opposite rotational direction compared to the first strut 34 and first locking formation 38.

With such a configuration, the clutch members 12 and 14 may be coupled together for rotation in the first direction 48, in the second direction 58, or in both directions 48 and 58. Furthermore, freewheeling of the first clutch member 12 with respect to the second clutch member 14 may only be permitted in the first direction 48, and only when the first strut 34 is disengaged from the first locking formation 38. When the first clutch member 12 rotates in the second direction 58, the second spring 56 automatically urges the second strut 36 into engagement with the second locking formation 40, thereby coupling the clutch members 12 and 14 together.

Although the clutch 10 is shown in the drawings with a single first strut 34 and a single second strut 36, the clutch 10 may be provided with any suitable number of struts. For example, the clutch 10 may be provided without any second struts 36. As another example, the clutch 10 may be provided with multiple first struts 34 and corresponding first pockets 30 and first springs 44, and multiple second struts 36 and corresponding second pockets 32 and second springs 56. Moreover, the clutch 10 may be formed with multiple first locking formations 38, such as notches, that are engageable with the first struts 34, and multiple second locking formations 40, such as notches, that are engageable with the second struts 36.

Each first strut 34 may be actuated in the same manner as described above with respect to the first mentioned first strut 34. Furthermore, the first fluid passage 46 may include a circumferential portion 60 and multiple connector portions 62 that extend between the circumferential portion 60 and the first pockets 30. With such a configuration, the first fluid passage 46 may selectively supply pressurized fluid from a single pressurized fluid source, such as pump 50, toward each of the first pockets 30.

FIG. 5 shows a second embodiment 10′ of an overrunning coupling assembly, such as a clutch, having components that are similar to the clutch 10 and that are identified with similar reference numbers. The clutch 10′, however, includes a second strut 36′ that, like the first strut 34, is also fluid actuated. More specifically, the clutch 10′ includes a second piston 64 that is moveable into second pocket 32 for urging the second strut 36′ into contact with the second locking formation 40 of the second clutch member 14, a second biasing member, such as a second spring 66, attached to first clutch member 12′ for biasing the second strut 36′ against pivotal movement, and a second fluid passage 68 formed in the first clutch member 12′ for selectively supplying pressurized fluid, such as hydraulic fluid, toward the second pocket 32 to move the second piston 64 into the second pocket 32.

Upon supply of pressurized fluid to the second fluid passage 68, the second piston 64 engages the second strut 36′ and pivots the associated strut end against the bias of the second spring 66 and into contact with the second locking formation 40 to couple the clutch members 12′ and 14 for rotation with each other in the second direction 58 about the axis 16. Upon termination of the supply of pressurized fluid to the second fluid passage 68, the second spring 66 is configured to move the end of the second strut 36′ back into the second pocket 32 to permit relative rotational movement of the first clutch member 12′ with respect to the second clutch member 14 in the second direction 58 about the axis 16.

The first and second struts 34 and 36′ may be actuated together or independently. For example, the fluid passages 46 and 68 may be connected by a common passage and supplied fluid by the same source. As a result, the struts 34 and 36′ may be actuated generally simultaneously to couple the clutch members 12′ and 14 together for rotation in either direction 48 or 58. As another example, the fluid passages 46 and 68 may be connected to separate fluid sources, such as separate pumps, or to one or more valves that can selectively supply fluid to the passages 46 and 68 such that the struts 34 and 36′ may be actuated independently.

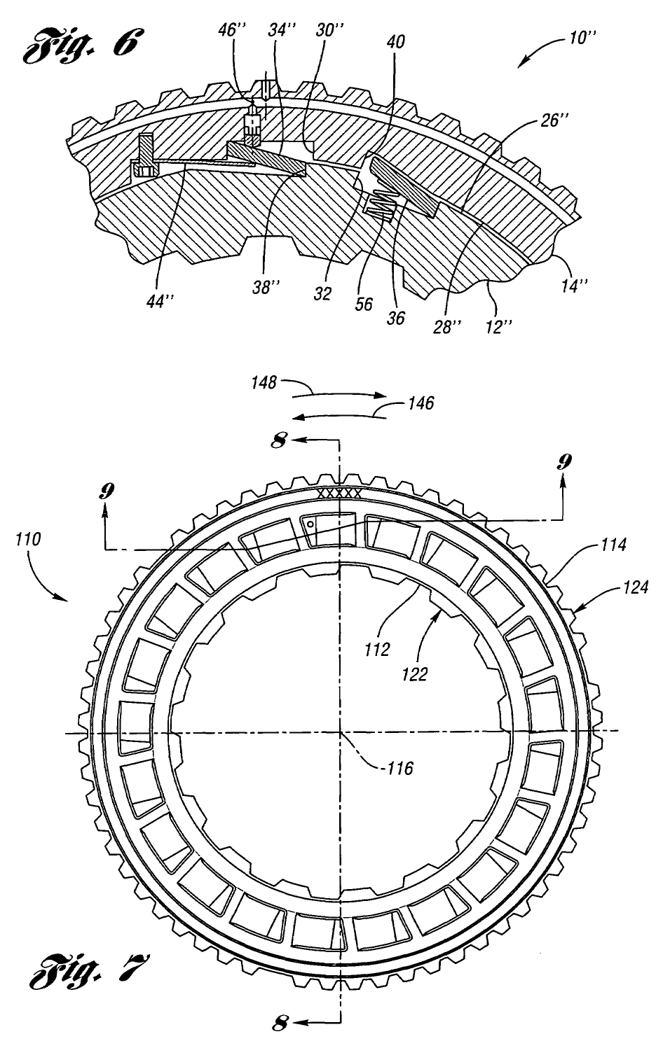

In any of the above embodiments, one or more of the pockets 30 and 32 and corresponding struts 34, 36 and 36′ may be associated with the second clutch member 14, instead of the first clutch member 12 or 12′. Referring to FIG. 6, for example, a third embodiment 10″ of an overrunning assembly, such as a clutch, is shown with first pocket 30″ formed in coupling face 28″ of second clutch member 14″, and first strut 34″ disposed in the first pocket 30″. Second clutch member 14″ also has a fluid passage 46″ for selectively supplying pressurized fluid toward the first pocket 30″ to move piston 42″ into first pocket 30″ and thereby pivot an end of first strut 34″ against the bias of first spring 44″ and into contact with first locking formation 38″ formed in the coupling face 26″ of first clutch member 12″.

Pressurized fluid may be supplied to fluid passage 46″ in a manner similar to that described above with respect to the clutch 10. For example, a shaft (not shown) coupled to second clutch member 14″ may be provided with a channel or other passage that is in fluid communication with a pump (not shown) and fluid passage 46″.

Referring to FIGS. 7-9, a fourth embodiment 110 of an overrunning coupling assembly is shown. The overrunning coupling assembly in this embodiment is configured as a planar clutch 110 having first and second coupling members, such as first and second clutch members 112 and 114, respectively. The clutch members 112 and 114 are rotatably supported with respect to each other for relative rotation about a rotational axis 116 of the clutch 110. For example, the first clutch member 112 may be a driving member that is coupled to a drive shaft 118, or other suitable arrangement, and the second clutch member 114 may be a driven member that is coupled to a driven shaft 120, or other suitable arrangement. As another example, the first clutch member 112 may be a driven member, and the second clutch member 114 may be a drive member. As yet another example, one of the clutch members 112 or 114 may be stationary.

Although the clutch members 112 and 114 may be coupled to the shafts 118 and 120 in any suitable manner, in the embodiment shown in FIGS. 7-9, the first clutch member 112 includes a splined inner surface 122 that receives the drive shaft 118, and the second clutch member 114 has a splined outer surface 124 that receives the driven shaft 120. Moreover, the first clutch member 112 has a coupling face 126 that opposes a coupling face 128 of the second clutch member 114. In this embodiment, the coupling faces 126 and 128 are generally planar and face generally axially in opposite directions.

In the embodiment shown in FIG. 9, the first clutch member 112 includes first and second sections 130 and 132, respectively, that are joined together in any suitable manner, such as by a brazing process. Furthermore, the sections 130 and 132 may be made of any suitable material. For example, the first section 130 may be made from powdered metal and the second section 132 may be made of stamped metal. As another example, the first clutch member 112 may be formed as a single piece. With either configuration, the clutch 110 may include a retainer 133, such as a weir, for retaining the clutch members 112 and 114 in close association.

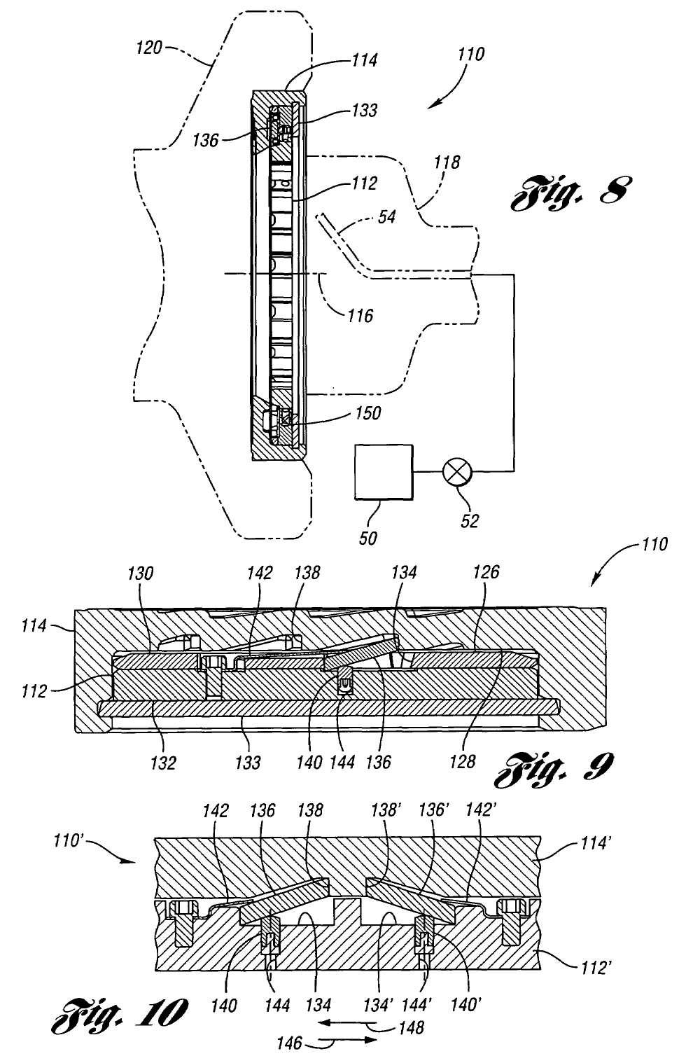

Referring to FIGS. 8 and 9, the sections 130 and 132 cooperate to define one or more pockets 134 in the coupling face 126, and each pocket 134 receives an engaging member, such as pawl or strut 136. For example, the first clutch member 112 may be formed with 4 or more pockets 134.

The struts 136 are moveable with respect to the first clutch member 12 such that the struts 136 are selectively engageable with locking formations 138, such as notches, formed in the coupling face 128 of the second clutch member 114, as explained below in detail. For example, the struts 136 may be pivotally moveable such that ends of the struts 136 project outwardly of the associated pockets 134.

Referring to FIG. 9, the clutch 110 further includes multiple pistons 140 (only one piston 140 is shown in FIG. 9) that are each moveable into a respective pocket 134 for urging the associated strut 136 into contact with a particular locking formation 138, and multiple biasing members, such as springs 142 (only one spring 142 is shown in FIG. 9), attached to the first clutch member 112 for biasing the struts 136 against pivotal movement. A fluid passage 144 is formed in the first clutch member 12 for selectively supplying pressurized fluid, such as hydraulic fluid, toward the pockets 134 to move the pistons 140 into the pockets 134. Upon supply of pressurized fluid to the fluid passages 144, each piston 140 may be urged into engagement with a respective strut 136 to cause the associated strut end to pivot against the bias of the associated spring 142 and into contact with a respective locking formation 138 to thereby couple the clutch members 112 and 114 for rotation with each other in a first direction 146 about the axis 116. Upon termination of the supply of pressurized fluid to the fluid passage 144, each spring 142 is configured to move the end of a respective strut 136 back into the associated pocket 134 to permit relative rotational movement of the first clutch member 112 with respect to the second clutch member 114 in the first direction 146 about the axis 116, as well as in a second direction 148 opposite the first direction 146.

Forming the first clutch member 112 in multiple sections 130 and 132 may facilitate formation of the fluid passage 144. For example, a generally circumferential portion 150 of the fluid passage 144 may be molded or otherwise formed in the second section 132, and then the first section 130 may be joined to the second section 132 to define an outer wall of the circumferential portion 150.

FIG. 10 shows a fifth embodiment 110′ of a clutch having components that are similar to the clutch 110 and that are identified with similar reference numbers. The clutch 110′, however, includes one or more additional struts 136′ that are each received in a corresponding additional pocket 134′ and that are each selectively engageable with one or more additional locking formations 138′, such as notches, formed in second clutch member 114′. Furthermore, the additional struts 136′ and additional pockets 134′ are oriented to cooperate with the additional locking formations 138′ in the opposite rotational direction compared to the struts 136, pockets 134 and locking formations 138.

The clutch 110′ further includes one or more additional pistons 140′ that are each moveable into a respective additional pocket 134′ for urging the associated additional strut 136′ into contact with a particular locking formation 138′. Moreover, the clutch 110′ includes one or more additional biasing members, such as additional springs 142′, that are each associated with a respective additional strut 136′ for urging the additional strut 136′ toward the associated additional pocket 134′.

The first clutch member 112′ includes an additional fluid passage 144′ having portions that extend to each additional pocket 134′, for selectively supplying pressurized fluid, such as hydraulic fluid, toward the additional pockets 134′ to move the additional pistons 140′ into the additional pockets 134′. Upon supply of pressurized fluid to the additional fluid passage 144′, each additional piston 140′ may be urged into engagement with a respective additional strut 136′ to cause the associated strut end to pivot against the bias of the associated additional spring 142′ and into contact with a respective additional locking formation 138′ to thereby couple the clutch members 112′ and 114′ for rotation with each other in the second direction 148 about the axis 116. Upon termination of the supply of pressurized fluid to the additional fluid passage 144′, each additional spring 142′ is configured to move the end of a respective additional strut 136′ back into the associated additional pocket 134′ to permit relative rotational movement of the first clutch member 112′ with respect to the second clutch member 114′ in the first and second directions 146 and 148, respectively.

With the above configuration, the clutch members 112′ and 114′ may be coupled together for rotation (1) only in the first direction 146 by actuating only the struts 136, (2) only in the second direction 148 by actuating only the additional struts 136′, or (3) in both directions 146 and 148 by actuating the struts 136 and the additional struts 136′. Furthermore, freewheeling of either clutch member 112′ or 114′ may be permitted in one or both directions 146 and 148 by terminating supply of pressurized fluid to the appropriate fluid passage or passages 144, 144′.

As another example, the one or more additional struts 136′ of clutch 110′ may be spring actuated, instead of fluid actuated. In such case, the associated additional pistons 140′, additional springs 142′ and additional fluid passage 144′ may be eliminated, and each additional pocket 134′ may have a spring (not shown) disposed therein for urging the associated additional strut 136′ into engagement with a respective additional locking formation 138′. With such a configuration, the clutch 110′ may operate in a similar manner as clutch 10.

While embodiments of the invention have been illustrated and described, it is not intended that these embodiments illustrate and describe all possible forms of the invention. Rather, the words used in the specification are words of description rather than limitation, and it is understood that various changes may be made without departing from the spirit and scope of the invention. For example, in any of the above embodiments, one or more of the associated struts may be actuated directly by fluid pressure, such that the corresponding piston may be omitted.

What is claimed is:

1. An overrunning clutch comprising:
first and second clutch members that are rotatably supported with respect to each other for relative rotation about a rotational axis of the clutch, the first and second clutch members having respective coupling faces that oppose each other;
the coupling face of one of the clutch members having a pocket;
the coupling face of the other clutch member having a locking formation;
a strut received within the pocket in the coupling face of the one clutch member and having an end that is pivotally movable outwardly of the pocket;
a spring that biases the strut against pivotal movement of the end out of the pocket toward the locking formation of the coupling face of the other clutch member; and
a fluid passage in the one clutch member for selectively supplying pressurized hydraulic fluid toward the pocket to pivot the strut end against the bias of the spring and into contact with the locking formation to couple the clutch members for rotation with each other in one direction about the rotational axis;
wherein upon termination of the supply of pressurized hydraulic fluid, the spring is configured to move the strut end back into the pocket to permit relative rotational movement of the one clutch member with respect to the other clutch member in the one direction about the rotational axis.

2. An overrunning clutch as in claim 1 wherein the coupling faces of the first and second clutch members are generally flat and face generally axially in opposite directions.

3. An overrunning clutch as in claim 1 wherein the coupling faces of the first and second clutch members are generally annular and face generally radially with respect to the rotational axis of the clutch.

4. An overrunning clutch as in claim 1 wherein the coupling face of the one clutch member includes a plurality of pockets and the other clutch member includes a plurality of locking formations, and wherein the clutch further includes a plurality of struts and springs respectively associated with the pockets of the coupling face of the one clutch member in the same manner as the first mentioned pocket, strut and spring, and wherein the fluid passage in the one clutch member selectively supplies pressurized hydraulic fluid toward the pockets to pivot the struts against the bias of their associated springs and into contact with the locking formations such that the struts cooperate in coupling the clutch members for rotation with each other in the one direction about the rotational axis, and wherein upon termination of the supply of pressurized hydraulic fluid, the springs urge the struts away from the locking formations to permit relative rotational movement of the clutch members with respect to each other about the rotational axis.

5. An overrunning clutch as in claim 1 wherein the coupling face of the one clutch member includes an additional pocket and the other clutch member includes an additional locking formation, and wherein the clutch further includes an additional strut and an additional spring associated with the additional pocket in the same manner as the first mentioned pocket, strut and spring, but the additional strut and the additional spring are oriented to cooperate with the additional locking formation in the opposite rotational direction to the one first mentioned, the one clutch member further including an additional fluid passage for selectively supplying pressurized hydraulic fluid toward the additional pocket to pivot the additional strut against the bias of the additional spring and into contact with the additional locking formation to couple the clutch members for rotation with each other in the other direction about the rotational axis, and wherein upon termination of the supply of pressurized hydraulic fluid to the additional fluid passage, the additional spring urges the additional strut away from the additional locking formation to permit relative rotational movement of the one clutch member with respect to the other clutch member in the other direction about the rotational axis.

6. An overrunning clutch as in claim 1 further comprising a piston disposed in the fluid passage and being engageable with the strut.

7. An overrunning clutch as in claim 1 wherein the fluid passage is configured to supply pressurized hydraulic fluid into the pocket to pivot the strut end against the bias of the spring and into contact with the locking formation to couple the clutch members for rotation with each other in the one direction about the rotational axis.

8. A coupling assembly comprising:
a first coupling member having a pocket and a fluid passage that extends toward the pocket;
a second coupling member having a locking formation; and
an engaging member received in the pocket, the engaging member being engageable with the locking formation;
wherein the fluid passage is configured to supply pressurized fluid toward the pocket to move the engaging member into contact with the locking formation to effect torque transfer between the coupling members.

9. The coupling assembly of claim 8 wherein the coupling members are rotatable about an axis, and each coupling member has a coupling face that faces generally axially, and wherein the coupling face of the first coupling member includes the pocket, and the coupling face of the second coupling member includes the locking formation.

10. The coupling assembly of claim 8 wherein the coupling members are rotatable about an axis, and each coupling member has a coupling face that faces generally radially with respect to the axis, and wherein the coupling face of the first coupling member includes the pocket, and the coupling face of the second coupling member includes the locking formation.

11. The coupling assembly of claim 8 wherein the first coupling member includes an additional pocket and the second coupling member includes an additional locking formation, and wherein the coupling assembly further includes an additional engaging member that is received in the additional pocket, and wherein the fluid passage in the first coupling member selectively supplies pressurized fluid toward the additional pocket to move the additional engaging member into contact with the additional locking formation such that the additional engaging member cooperates with the engaging member to couple the coupling members for rotation with each other in one direction about an axis, and wherein upon termination of the supply of pressurized hydraulic fluid, the engaging members are permitted to disengage the locking formations to permit relative rotational movement of the coupling members with respect to each other about the axis.

12. The coupling assembly of claim 8 further comprising a piston disposed in the fluid passage and being engageable with the engaging member.

13. The coupling assembly of claim 8 wherein the fluid passage is configured to supply pressurized fluid into the pocket to move the engaging member into contact with the locking formation to effect torque transfer between the coupling members.

14. The coupling assembly of claim 8 wherein the coupling members rotate together in a first direction about an axis when the engaging member is in contact with the locking formation, and wherein upon termination of the supply of pressurized fluid, the engaging member is permitted to disengage the locking formation to allow relative rotational movement of one coupling member with respect to the other coupling member in the first direction about the axis.

15. The coupling assembly of claim 14 wherein the first coupling member includes an additional pocket and the second coupling member includes an additional locking formation, and wherein the coupling assembly further includes an additional engaging member associated with the additional pocket, the first coupling member further including an additional fluid passage for selectively supplying pressurized fluid toward the additional pocket to move the additional engaging member into contact with the additional locking formation to couple the coupling members for rotation with each other about the axis in a second direction opposite the first direction, and wherein upon termination of the supply of pressurized fluid to the additional fluid passage, the additional engaging member is disengageable from the additional locking formation to permit relative rotational movement of one coupling member with respect to the other coupling member in the second direction.

16. The coupling assembly of claim 15 further comprising first and second pistons disposed in the fluid passage and the additional fluid passage, respectively, and being engageable with the engaging member and the additional engaging member, respectively.

17. A clutch comprising:
first and second clutch members that are rotatably supported for rotation about a rotational axis of the clutch, the first and second clutch members having respective coupling faces that oppose each other;
the coupling face of one of the clutch members having a pocket;
the coupling face of the other clutch member having a locking formation;
a strut received within the pocket of the coupling face of the one clutch member and having an engaging portion that is movable away from the pocket; and
a fluid passage in the one clutch member for selectively supplying pressurized fluid to the pocket to move the engaging portion of the strut into contact with the locking formation to couple the clutch members for rotation in one direction about the rotational axis;
wherein upon termination of the supply of pressurized fluid, the engaging potion of the strut is permitted to move back toward the pocket to allow relative rotational movement of the one clutch member with respect to the other clutch member about the rotational axis.
